(19) United States
(12) Patent Application Publication
(10) Pub. No.: US 2020/0014668 A1
(43) Pub. Date: Jan. 9, 2020

(54) SYSTEM AND METHOD OF SECURELY TRANSMITTING AND STORING DATA OVER A NETWORK

(71) Applicants: Robert Statica, Long Valley, NJ (US); Kara Coppa, Long Valley, NJ (US)

(72) Inventors: Robert Statica, Long Valley, NJ (US); Kara Coppa, Long Valley, NJ (US)

(21) Appl. No.: 16/439,242

(22) Filed: Jun. 12, 2019

Related U.S. Application Data
(60) Provisional application No. 62/656,954, filed on Apr. 12, 2018.

(51) Int. Cl. H04L 29/06; H04L 9/06; H04L 9/14

(52) U.S. Cl. CPC H04L 63/0478; H04L 9/0618; H04L 63/061; H04L 2209/38; H04L 2209/56; H04L 9/14

(57) ABSTRACT

A system and method of securely storing data across a network. The system and method includes the generation of a digital asset via software running on a computer. The digital asset is a data packet divided into a plurality of fragments, and at least two of the plurality of fragments are encrypted using a different cipher.

### CROSS-REFERENCE TO RELATED APPLICATION

This application claims the benefit of priority of U.S. provisional application No. 62/656,954, filed Apr. 12, 2018, the contents of which are herein incorporated by reference.

### BACKGROUND OF THE INVENTION

The present invention relates to a system and method of securely transmitting and storing data over a network.

Blockchain technology (“blockchains”) and cryptocurrencies have exploded in growth. In this regard, blockchains provide supposed immutable ledgers and cryptocurrencies provide decentralized digital currency without the need of a central bank to back the currency. While blockchains and cryptocurrencies are linked, they are separate technologies, each with their advantages and disadvantages.

Blockchain is a data structure that represents a record of a transaction. The transaction may be, for example, financial—such as the transfer of funds or a sale of goods and/or services, a property transfer, tracking goods through a supply chain, etc. Each transaction is digitally signed via a hashing algorithm to ensure the authenticity of the transaction. When a new transaction or an edit to an existing transaction comes in to a blockchain, a majority of the nodes evaluate and verify the history of the individual blockchain block that is proposed. If a majority of the nodes come to a consensus that the history and signature is valid, the new block of transactions is accepted into the ledger and a new block is added to the chain of transactions. If a majority of the nodes do not reach consensus, the transaction is denied and not added to the chain. Accordingly, the ledger and the existing transactions are presumed to be of high integrity.

Cryptocurrencies, on the other hand, are digital assets designed to work as a medium of exchange that uses cryptographic algorithms as the foundation of its transactions, to control the creation of additional units, and to verify the transfer of assets. Cryptocurrencies are denominated as “coins.” Coins are mined by performing the cryptographic calculations (i.e., calculating the hashes and signatures) necessary to append a transaction to the end of a blockchain. Miners are unknown, unverified, and compete against each other to perform the cryptographic calculations needed to earn a coin.

Blockchain and cryptocurrencies present a new and revolutionary technology for conducting, recording, and managing transactions. However, blockchain and cryptocurrencies are not without their disadvantages. For instance, committing a transaction to a blockchain is time-consuming, taking up to seven seconds to commit a transaction to Bitcoin, the world's most well-known blockchain. While seven seconds does not seem long, millions of electronic financial transactions occur every second. Thus, seven seconds for a single financial transaction is equivalent to millennia.

Not only is committing a transaction to a blockchain a time-consuming action; it is also a resource-consuming action. To mine a single Bitcoin, the cost is approximately $4600 USD and consumes approximately 383 kg of carbon dioxide. This is roughly equivalent to the power required to provide 26 U.S. households with power. Thus, committing transactions to a blockchain and mining coins are both a time- and resource-intensive endeavor.

Additionally, blockchain and cryptocurrencies have security flaws. In 2017, over $1.5 billion USD were stolen from the top five cryptocurrency exchanges. In this regard, blockchain transactions are vulnerable both in-transit and at-rest. For instance, transactions are oftentimes only encrypted using Secure Sockets Layer (SSL), which has known vulnerabilities. Further, transactions are susceptible to man-in-the-middle attacks. Furthermore, cryptocurrency wallets, the software and/or hardware that stores keys and interacts with blockchains, store their contents in plaintext (i.e. unencrypted) and rely on no more than a password for protection. Moreover, current blockchain and cryptocurrency technology does not include verification techniques. Thus, there is no mechanism to detect forgery, interception, or tampering. Looking forward, there are no blockchain or cryptocurrency that is immune to quantum cryptography.

Finally, blockchain and cryptocurrencies have a volatility problem. In 2017, cryptocurrencies exhibited price changes of up to 200% in a single day, making them difficult to implement in the real world.

Cryptocurrency exchanges have technical problems with committing transactions to a blockchain in a time efficient and secure manner. Furthermore, cryptocurrency wallets are highly technical and susceptible to malicious users. Finally, the lack of security surrounding blockchain and the volatility of cryptocurrencies act as another hindrance to the wide-scale adoption of both technologies.

As can be seen, there is a need in the art to solve these, and other, technical problems surrounding blockchain and cryptocurrency technology.

### SUMMARY OF THE INVENTION

In one aspect of the present invention, a method of securely transmitting and storing data across a network, the method comprises steps of generating, via software running on a computer, a digital asset; dividing, via software running on the computer, the digital asset into a plurality of fragments, and encrypting, via software running on the computer, at least two of the plurality of fragments using a different fragment cipher.

In another aspect of the present invention, a system for securely transmitting and storing data across a network, the system comprises: at least one processor; at least one memory; at least one communications interface for communicating over the network; and a plurality of program instructions stored in the at least one memory, that when executed by the at least one processor, cause the at least one processor to: generate a digital asset, wherein the digital asset is a data packet divided into a plurality of fragments, and at least two of the plurality of fragments are encrypted using a different fragment cipher.

These and other features, aspects and advantages of the present invention will become better understood with reference to the following drawings, description and claims.

### BRIEF DESCRIPTION OF THE DRAWINGS

FIG. 1 is a schematic view illustrating fragments of a cryptocurrency packet;

FIG. 2 is a schematic view illustrating encryption, authentication, and key exchange for each of the fragments of the cryptocurrency packet; and

FIG. 3 is a schematic view illustrating an exemplary encryption of the blockchain of the present invention.

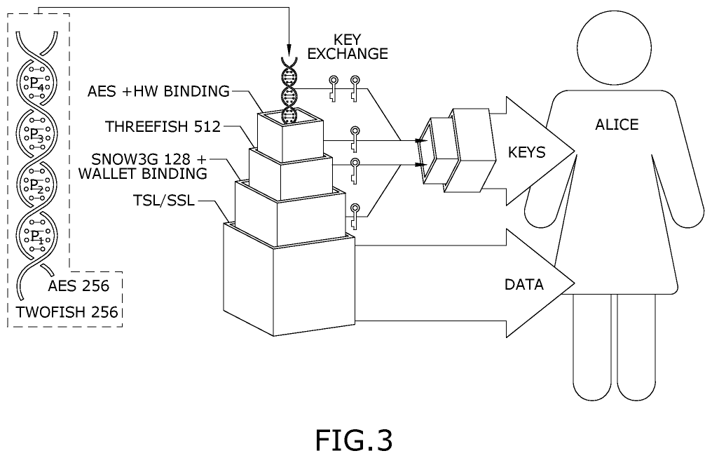

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present disclosure describes systems, methods, and non-transitory computer-readable media that include instructions to solve the technical problems discussed above. In particular, the present disclosure describes a faster, more secure cryptocurrency that is more resistant to cryptanalysis. Additionally, the present disclosure describes a more secure cryptocurrency wallet by binding transactions to the hardware of the cryptocurrency wallet. Lastly, the present disclosure discusses a secure ledger that allows transactions to be committed to the secure ledger in a secure, time- and energy-efficient manner.

The embodiments described herein with reference to the accompanying drawings, in which like reference numerals may refer to identical or functionally similar elements, and descriptions below are provided for the purpose of describing aspects of the present invention. Further, the terminology used herein is for the purpose of describing particular embodiments only and is not intended to be limiting of the disclosed embodiments. As used herein, the singular forms “a,” “an,” and “the” are included to include the plural forms as well, unless context clearly defines otherwise. It will be further understood that the terms “comprises” and/or “comprising,” when used in the specification, specify the presence of stated features, integers, steps, operations, elements, and/or components, but do not preclude the presence of one or more additional features, integers, steps, operations, elements, and/or groups thereof.

Unless otherwise defined, all terms (including technical and scientific terms) used herein shall be given their plain and ordinary meaning as understood by one of ordinary skill in the art. It will be further understood that terms such as those defined in commonly used dictionaries, should be interpreted as having a meaning that is consistent with their meaning in the context of the relevant art and will not be interpreted in an idealized or overly formal sense unless expressly so defined herein.

The present invention may be embodied as a method, system, and/or as computer program instructions stored on a non-transitory computer-readable medium. Accordingly, the embodiments may take the form of hardware, software, or a combination thereof. Any suitable non-transitory computer-readable medium or processor-readable medium may be utilized including, for example, but not limited to, hard disks, USB Flash Drives, DVDs, CD-ROMs, optical storage devices, magnetic storage devices, etc. The instructions may be written in any suitable programming and/or scripting language, such as Java, C, C++, C#, Python, erlang, PHP, etc.

The disclosed embodiments are described, in part below, with reference to flowchart illustrations and/or block diagrams of methods, systems, computer program products, and data structures according to embodiments of the invention. It will be understood that each block of the illustrations, and combinations of blocks, can be implemented by computer program instructions. These computer program instructions may be provided to a processor of a general-purpose computer, special-purpose computer, or other programmable data processing apparatus to produce a machine such that the instructions, which execute via the processor of the computer or other programmable data processing apparatus, create means for implementing the functions/acts specified in the block or blocks.

Note that the instructions described herein such as, for example, the operations/instructions and steps discussed herein, and any other processes described herein can be implemented in the context of hardware and/or software. In the context of software, such operations/instructions of the methods described herein can be implemented as, for example, computer-executable instructions such as program modules being executed by a single computer or a group of computers or other processors and processing devices. In most instances, a “module” constitutes a software application.

Generally, program modules include, but are not limited to, routines, subroutines, software applications, programs, objects, components, data structures, etc., that perform particular tasks or implement particular abstract data types and instructions. Moreover, those skilled in the art will appreciate that the disclosed method and system may be practiced with other computer system configurations such as, for example, hand-held devices, multi-processor systems, data networks, microprocessor-based or programmable consumer electronics, networked PCs, tablet computers, remote control devices, wireless handheld devices, Smartphones, mainframe computers, servers, and the like.

The term module, as utilized herein, may refer to a collection of routines and data structures that perform a particular task or implements a particular abstract data type. Modules may be composed of two parts: an interface, which lists the constants, data types, variable, and routines that can be accessed by other modules or routines; and an implementation, which is typically private (accessible only to that module) and which includes source code or machine code that actually implements the routines in the module. The term module may also simply refer to an application such as a computer program designed to assist in the performance of a specific task such as word processing, accounting, inventory management, etc. Additionally, the term “module” can also refer in some instances to a hardware component such as a computer chip or other hardware.

Alternatively, each block, and/or combinations of blocks, may be implemented by special purpose hardware, software, or firmware operating on special or general-purpose data processors, or combinations thereof. It should also be noted that, in some alternative implementations, the operations noted in the blocks may occur in an order different from the one indicated in the figures. For example, two blocks shown in succession may in fact be executed substantially concurrently, or the blocks may sometimes be executed in the reverse order, or the varying embodiments described herein can be combined with one another or portions of such embodiments can be combined with portions of other embodiments in another embodiment.

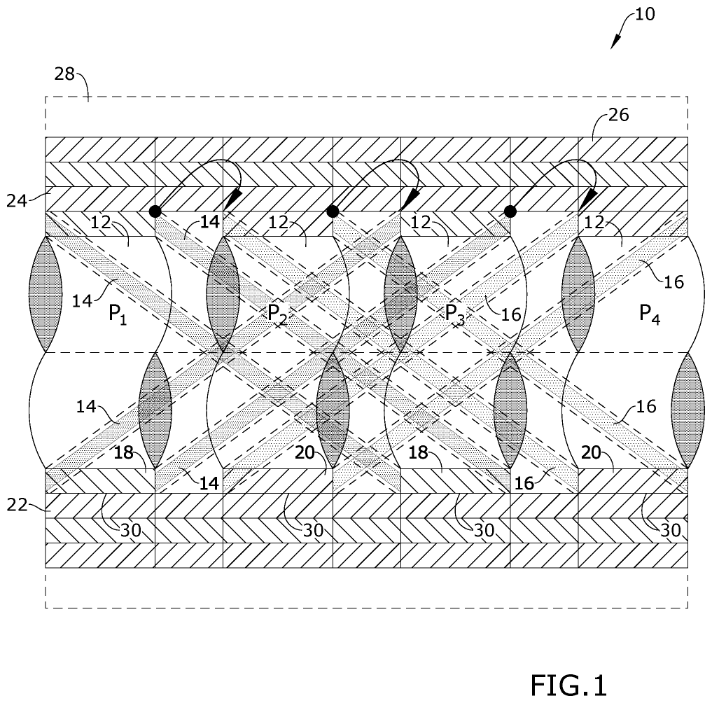

FIG. 1 is a schematic view illustrating a digital asset. The digital asset is a data packet 10 divided into a pluraliyt fragments 12. Each of the fragments 12 may be encrypted with the following:

14: DNA Helix Strand Encryption (DNA-HSE) with a first fragment Cipher

16: DNA Helix Strand Encryption (DNA-HSE) with a second fragment Cipher

18: Symmetric Encryption first fragment Cipher

20: Symmetric Encryption second fragment Cipher

22: Symmetric Encryption first packet Cipher (with hardware binding)

24: Symmetric Encryption second packet Cipher (post quantum cipher)

26: Symmetric Encryption third packet Cipher (with BLΔKWallet binding)

28: External Encryption with TLS/SSL (in transit only)

30: Hardware Binding Encryption With the third Cipher
Encrypt every X/4 Bytes of a standard BLΔKCoin packet of X Bytes with alternating ciphers (here is shown as first Cipher and second Cipher)
Each cipher (first Cipher and second Cipher) is also encrypted with the next fragment cipher in the DNA-HSE

The digital asset may include a block linked to other blocks of a blockchain. Alternatively, the digital asset may include an email, text message, classified files, or any type of data file that is transmitted and stored on a computing device. The digital assets are a data packet 10 that uses a plurality of ciphers to encrypt data and encryption keys, like a DNA Helix. In this regard, the data is divided into one or more fragments 12. Each fragment 12 is encrypted using a different cipher with a different encryption algorithm and a different encryption key. According to some embodiments, at least one of the encryption algorithms is a post-quantum encryption algorithm to protect against cryptanalysis performed by quantum computers. Moreover, the secure cryptocurrency packet 10 of the present disclosure employs a plurality of encryption algorithms at various stages to provide additional layers of security on the overall transmission to significantly reduce the risk of a successful brute force attack. Additionally, there is no need to mine the secure cryptocurrency of the present disclosure. Finally, the secure cryptocurrency of the present disclosure is bound to the hardware of the recipient's cryptocurrency wallet. Specifically, the secure cryptocurrency secures data using a unique hardware identifier and a unique software identifier of the intended receiver.

The cryptocurrency of the present invention is a digital communication and digital asset storage packet 10 that is found in transit (between two different users, or between the use and the cryptocoin exchange) or at rest (inside a user's wallet) on user devices. The coin is protected both in transit and at rest by a multilayer, multi threaded and DNA Helix Strand Encryption (DNA-HSE) with primitives that provide pre- and post-quantum computing immunity while being bound to the hardware fingerprint of user devices and the software fingerprint of the wallet (i.e. the BLΔKWallet).

### EXAMPLE

BLAKCoin Packet 10 of X Bytes in broken into four separate fragments 12:
   Fragment P1: first fragment Cipher 18(Coin Fragment 1)+second fragment Cipher 20 (first fragment Cipher 18)
   Fragment P2: second fragment Cipher 20 (Coin Fragment 2)+first fragment Cipher 18 (second fragment Cipher 20)
   Fragment P3: first fragment Cipher 18 (Coin Fragment 3)+second fragment Cipher 20 (first fragment Cipher 18)
   Fragment P4: second fragment Cipher 20 (Coin Fragment 4)+first fragment Cipher 18 (second fragment Cipher 20)
Where each Coin Fragment 12 represents the X/4 Bytes portion of the plain text found in every X Bytes standard BLAKCoin packet 10.
   Post Quantum Hash Algorithm: HMAC SHA3 512 (or similar cipher)
   Pre Quantum Hash Algorithm: MHAC SHA512 (or similar cipher)
   Digital Signatures: ECDSA521 (or similar cipher)
      SHA3[[SHA512 [first fragment Cipher 18 (Coin Fragment 1)]];
      SHA3[[SHA512 [second fragment Cipher 20 (Coin Fragment 2))];
      SHA3[[SHA512 [first fragment Cipher 18 (Coin Fragment 3)]];
      SHA3[[SHA512 [second fragment Cipher 20 (Coin Fragment 4)]]

Include in each fragment SHA3 signatures of previous packets and next packets (chain like inclusion in order to allow for integrity check and position in the original packet of each of the fragments).

### Possible Symmetric Primitives Used:

First Fragment Cipher 18→AES256 (GCM Mode) (or similar cipher)
Second Fragment Cipher 20→TwoFISH 256 (or similar cipher)
First Packet Cipher 22→AES256 (GCM Mode) (or similar cipher)
Second Packet Cipher 24→ThreeFISH 512 (or similar cipher)
Third Packet Cipher 26→Snow3G 128 (or similar cipher)

Ciphers used can be substituted with other symmetric ciphers depending on pre- and post-quantum computing immunity desired. With the ciphers shown, the coin has pre- and post-quantum computing immunity.

While the example above describes dividing the cryptocurrency packet 10 into four fragments 12, the cryptocurrency packet 10 can be divided into a fewer or greater number of fragments 12 based upon network conditions and the maximum transmission unit for the cryptocurrency network.

As mentioned above, a portion of the encryption (first pack Cipher 22) is bound to the calculated value of the unique DNA hardware fingerprint of the user device, server or cloud infrastructure where the coin is stored.

The unique hardware fingerprint of the devices may be calculated using the algorithm outlined below:
a) Take hashes of various hardware components of user's device:
SHA512 (CPUO_ID)=a hash that is 512 bits long=Part1cpu (256 bits); Part2cpu (256 bits) (split the result in two equal parts)
SHA512 (MBO_ID)=Part1mb; Part2mb
SHA512 (GPUO_ID)=Part1gpu; Part2gpu
SHA512 (MACO_ID)=Part1mac; Part2mac
b) Create a matrix and permutate boxes as shown below:

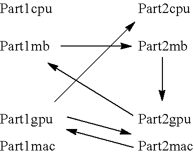

The new hash obtained after permutations is:
Part1cpu Part1mac Part2gpu Part1mb Part2mac Part2mb Part2cpu Part1gpu
c) Create multiple iterations of the new hash value obtained at step b):
If N is an integer, N=1, . . . , Xn. Xn to be determined during implementation
Then for N=1 to Xn
SHA512 [Part1cpu Part1mac Part2gpu Part1mb Part2mac Part2mb Part2cpu Part1gpu]
SHP=SHA3(Xn^{th} iteration of SHA)

SHA3 (or similar cipher) is used at the final iteration to provide a hash value that is also quantum computing attacks immune. This SHP result is the user's device hardware profile/fingerprint which is unique, used only once and never used by any other device. Other hardware addresses could be used as well, for example, the WiFi or BLUETOOTH™ MAC addresses and/or crypto card hardware address (if in use), etc.

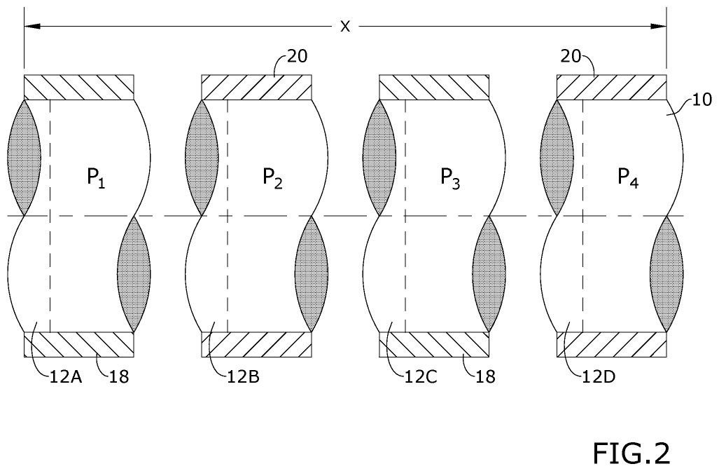

FIG. 2 illustrates encryption, authentication, and key exchange for each of the fragments 12a-12d of the cryptocurrency packet 10. FIG. 2 illustrates the following ciphers and fragments:

18: first fragment Cipher

20: second fragment Cipher

12a: Hash value of fragment P1 (Coin Fragment 1]
D=SHA3[Coin Fragment 1]

12b: Hash value of fragment P2 (Coin Fragment 2]
E=SHA3[Coin Fragment 2]+SHA3{SHA3[Coin Fragment 1]+SHA3[Coin Fragment 2]}

12c: Hash value of fragment P3 (Coin Fragment 3]
F=SHA3[Coin Fragment 3]+SHA3{SHA3[Coin Fragment 1]+SHA3[Coin Fragment 2]+SHA3[Coin Fragment 3]}

12e: Hash value of fragment P4 (Coin Fragment 4]
G=SHA3[Coin Fragment 4]+SHA3{SHA3[Coin Fragment 1]+SHA3[Coin Fragment 2]+SHA3[Coin Fragment 3]+SHA3[Coin Fragment 4]}

The cryptocurrency wallet (i.e., BLΔKWallet) of the present disclosure provides additional security by verifying each transaction using the unique hardware identifier and a unique software identifier for each transaction. The use of both the unique hardware identifier and the unique software identifier improves security surrounding each transaction recorded by the cryptocurrency wallet.

When the a cryptocurreny coin (BLΔKCoin) is received by a cryptocurrency wallet (BLΔKWallet), the following computation may take place, after the outer layers of the coin are decrypted:

The receiving BLΔKWallet is calculating:

1. SHA3[Received Coin Fragment 1]=WalletSHA(P1)

If WalletSHA(P1)=D=SHA3[Coin Fragment 1] then the two hashes are identical which means that the Received Coin Fragment 1 is intact and hasn't been altered (either intentionally by an intruder or an error occurred in transmission). If the two hashes are not identical, the Received Fragment 1 CANNOT be trusted and a NACK is securely sent back to the sender. Transaction is cancelled. All previous states are restored in the ledger

2. SHA3[Received Coin Fragment 2]=WalletSHA(P2)

If WalletSHA(P2)=E=SHA3[Coin Fragment 2] then the two hashes are identical which means that the Received Coin Fragment 2 is intact and hasn't been altered (either intentionally by an intruder or an error occurred in transmission). If the two hashes are not identical, the Received Fragment 2 CANNOT be trusted and a NACK is securely sent back to the sender. Transaction is cancelled. All previous states are restored in the ledger.

3. SHA3[Received Coin Fragment 3]=WalletSHA(P3)

If WalletSHA(P3)=F=SHA3[Coin Fragment 3] then the two hashes are identical which means that the Received Coin Fragment 3 is intact and hasn't been altered (either intentionally by an intruder or an error occurred in transmission). If the two hashes are not identical, the Received Fragment 3 CANNOT be trusted and a NACK is securely sent back to the sender. Transaction is cancelled. All previous states are restored in the ledger

4. SHA3[Received Coin Fragment 4]=WalletSHA(P4)

If WalletSHA(P2)=G=SHA3[Coin Fragment 4] then the two hashes are identical which means that the Received Coin Fragment 4 is intact and hasn't been altered (either intentionally by an intruder or an error occurred in transmission). If the two hashes are not identical, the Received Fragment 4 CANNOT be trusted and a NACK is securely sent back to the sender. Transaction is cancelled. All previous states are restored in the ledger.

In certain embodiments, each packet may be the same size of X Bytes to prevent statistical attacks on various sizes encrypted messaging packets. If the actual size of a packet is Y and if Y is smaller than the physical X Bytes packet, the present invention may incorporate randomly generated and encrypted characters as fillers to make up the difference. In order to prevent detection of fillers, the present invention may generate random characters and encrypt them with a random AES256 key. The key is generated randomly, used and then destroyed forensically from the volatile and stable memory of the device.

There is no need to do a key exchange for this key, or to send it to the recipient. The recipient won't be able to decrypt the filler, and the software may instruct the processor to ignore that part.

EXAMPLE: based on a packet size of 1500 Bytes

Generate RND AES 256

Generate RND Char to fill remaining (X-Y) Bytes (here 1500 Bytes-1400 Bytes=100 Bytes

Encrypt AES 256 (RND Char)=Filler Cipher

Insert portions of the Filler Cipher into the BLΔKCoin Packet based on a random function or after each of the Coin Fragments 1 . . . 4 where the size of each insertion is given by 100 Bytes/4. For simplicity, add 30 Bytes after the Coin Fragment 1, 30 Bytes after Coin Fragment 2, 30 Bytes after Coin Fragment 3 and 10 Bytes after Coin Fragment 4.

The bits that belong to the Filler Cipher are marked uniquely so they are easily identified and removed prior to decryption by the receiving device

While the example above describes a 1500 byte packet, any sized packet could be used based on network conditions and the needs of the cryptocurrency network and ledger.

The present invention further includes a secure ledger (i.e., BLΔKLedger) that increases scalability and throughput to more than 250,000 transactions per second. Each transaction is end-to-end encrypted and resistant to post-quantum cryptoanalysis using the secure cryptocurrency described above. The secure ledger of the disclosure includes built-in self-defense and provides anonymous, untraceable, and anti-eavesdropping transactions. The secure ledger meets and exceeds the cryptographic standards defined by financial institutions and top secret intelligence agencies. Additionally, the secure ledger of the present disclosure allows for private and permissioned distributions of the secure cryptocurrency, and each transaction is validated using one or more digital security standards. Each transaction is synchronized and subject to virtual voting in accordance with Byzantine fault tolerant protocols, such as the Federated Byzantine Agreement Consensus. This allows the secure ledger to process peer-to-peer (P2P) payment solutions on a universal ledger using smart contracts. Accordingly, the secure ledger described herein is decentralized, private, and provisioned with authenticated nodes to process both FIAT currencies, as well as cryptocurrencies

Unless otherwise stated, the foregoing alternative embodiments are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the embodiments described herein, as well as clauses phrased as “such as,” “including,” and the like, should not be interpreted as limiting the subject matter of the claims to the specific embodiments; rather, the embodiments are intended to illustrate only one of many possible embodiments.

What is claimed is:

1. A method of securely transmitting and storing data across a network, the method comprising steps of
generating, via software running on a computer, a digital asset;
dividing, via software running on the computer, the digital asset into a plurality of fragments, and
encrypting, via software running on the computer, at least two of the plurality of fragments using a different fragment cipher.

2. The method of claim 1, wherein the digital asset is a block linked to other blocks of a blockchain, wherein new data blocks are added each time a participating node in a network of nodes generates a new transaction and the network of nodes validates the new transaction

3. The method of claim 1, further comprising a step of:
encrypting, via software running on the computer, the entire data packet with at least one packet layer of encryption.

4. The method of claim 2, wherein the at least one packet layer of encryption comprises a plurality of packet layers of encryption comprising a first packet cipher, a second packet cipher, and a third packet cipher.

5. The method of claim 4, wherein the first packet cipher comprises a hardware binding.

6. The method of claim 5, wherein the hardware binding comprises is a unique hardware fingerprint of a user device, sever or cloud infrastructure where the digital asset is stored.

7. The method of claim 3, wherein the second packet cipher comprises a post quantum cipher.

8. The method of claim 3, wherein the third packet cipher comprises a crypto wallet cipher.

9. The method of claim 1, wherein the plurality of fragments is at least four fragments.

10. The method of claim 9, wherein the different ciphers comprise a first fragment cipher and a second fragment cipher, wherein the first fragment cipher and the second fragment cipher alternate from fragment to fragment.

11. The method of claim 10, wherein each of the first fragment cipher is encrypted with the second fragment cipher and each of the second fragment cipher is encrypted with the first fragment cipher.

12. The method of claim 1, wherein an external encryption layer encrypts the digital asset when the digital asset is in transmit between nodes.

13. A system for securely transmitting and storing data across a network, the system comprising:
at least one processor;
at least one memory;
at least one communications interface for communicating over the network; and
a plurality of program instructions stored in the at least one memory, that when executed by the at least one processor, cause the at least one processor to:
generate a digital asset, wherein
the digital asset is a data packet divided into a plurality of fragments, and
at least two of the plurality of fragments are encrypted using a different fragment cipher.

14. The system of claim 13, wherein the digital asset is a block linked to other blocks in a blockchain, wherein new data blocks are added each time a participating node in a network of nodes generates a new transaction and the network of nodes validates the new transaction

15. The system of claim 13, wherein at least one additional layer of encryption comprising a first packet cipher encrypts the entire data packet.

16. The system of claim 14, wherein the at least one additional layer of encryption comprises a plurality of layers of encryption comprising a first outer cipher, a second outer cipher, and a third outer cipher.

17. The system of claim 16, wherein the first outer cipher comprises a hardware binding.

18. The system of claim 17, wherein the hardware binding comprises a unique hardware fingerprint of a user device, sever or cloud infrastructure where a digital asset is stored.

19. The system of claim 13, wherein the different ciphers comprise a first fragment cipher and a second fragment cipher, wherein the first fragment cipher and the second fragment cipher alternate from fragment to fragment.

20. The system of claim 19, wherein each of the first fragment cipher is encrypted with the second fragment cipher and each of the second fragment cipher is encrypted with the first fragment cipher.
